(19) United States
(12) Patent Application Publication
(10) Pub. No.: US 2018/0193217 A1
(43) Pub. Date: Jul. 12, 2018

(54) APPARATUS TO APPLY FORCES IN A THREE-DIMENSIONAL SPACE

(71) Applicant: ECOLE POLYTECHNIQUE FEDERALE DE LAUSANNE (EPFL), Lausanne (CH)

(72) Inventors: Joachim VON ZITZEWITZ, Lausanne (CH); Heike VALLERY, Delfgauw (NL); Gregoire COURTINE, Lausanne (CH)

(21) Appl. No.: 15/741,719

(22) PCT Filed: Jul. 1, 2016
(86) PCT No.: PCT/EP2016/065601

§ 371 Date: Jan. 3, 2018

(30) Foreign Application Priority Data
Jul. 3, 2015 (EP) 15175238.3

(51) Int. Cl. A61H 3/00

(52) U.S. Cl. CPC A61H 3/008; A61H 2201/1652; A61H 2201/5092; A61H 2201/5061; A61H 2201/5064; A61H 2201/1659

(57) ABSTRACT

The present invention relates to a robotic system useful to unload the object/person from its weight. The robotic system is useful in locomotor rehabilitation programs and allows the manipulation of forces in a three-dimensional space with far lower actuator requirements and a much higher precision than prior-art systems. The apparatus combines passive and active elements to minimize actuation requirements while still keeping inertia to a minimum and control precision to a maximum. It requires minimal actuators and at the same time has a low inertia.

### FIELD OF THE INVENTION

The present invention relates to the field of robotic systems, in particular to robotic systems useful to apply forces to an object or a subject, in particular a person. It also relates to a robotic system useful to unload the object/person from its weight. More in particular, it relates to a robotic system useful in locomotor rehabilitation programs, for example in subjects suffering from spinal cord injuries or more generally to motion impairment.

### BACKGROUND OF THE INVENTION

In locomotor rehabilitation of patients with neurological impairments gait and balance training is essential.

Robotic overhead support systems have been developed to help patients training, for example by relieving them of part of their body weight.

Existing body-weight support systems or overhead gantry cranes are either not three-dimensional, i.e. they do not allow three-dimensional gait training, or they have high friction and inertia, or they require a multitude of strong and powerful actuators.

Systems known in prior art are conceptualized as classical serial (gantry) or parallel mechanism. In the former case, they require movable gantries to allow three-dimensional application of forces, which involves a massive structure with high inertia. In the case of parallel mechanisms, the actuated degrees of freedom (DOFs) are not decoupled from each other. Therefore, all actuators move in case of a single-DOF movement. Due to this coupling, it is almost impossible to apply forces in a precise manner over a large workspace. Additionally, all actuators have to be dimensioned taking the fastest velocity and the highest force/torque into account which do not necessarily occur in the same DOF.

For example, in Gosselin et al., “On the development of a walking rehabilitation device with a large workspace.” Rehabilitation Robotics (ICORR), 2011 IEEE International Conference on. IEEE, 2011, a fully passive system requiring a moving gantry is described. The system has the main objective to be able to follow the person with an overhead support and compensate part of its weight. The basic principle is a cable-routing system that follows the user in order to provide gravity compensation without hindering walking motions. Disadvantages of this system are its high inertia in the direction orthogonal to the moving gantry and that horizontal forces cannot be applied.

In WO2013117750 an apparatus for unloading a user's body weight, in particular for gait training, is disclosed. The apparatus is characterized by a plurality of ropes deflected by deflection devices and a node coupled to the free ends of said ropes and to a user. Drive units retract and release the ropes to adjust the rope force so as to obtain a resulting force exerted on the user via said node in order to unload the user and/or to exert a force on the user in a horizontal plane. This is a fully actuated system that requires strong and powerful actuators to work. This apparatus has been commercialized as THE FLOAT by Lutz Medical Engineering, Switzerland.

Similar systems are disclosed in Vallery, H., et al. “Multidirectional transparent support for overground gait training.” Rehabilitation Robotics (ICORR), 2013 IEEE International Conference on. IEEE, 2013 and Von Zitzewitz, Joachim, et al. “Use of passively guided deflection units and energy-storing elements to increase the application range of wire robots.” Cable-Driven Parallel Robots. Springer Berlin Heidelberg, 2013. 167-184.

These systems, which are a special class of parallel mechanisms, have the mentioned disadvantage that they require a multitude of strong and powerful actuators because the actuated degrees of freedom (DOFs) are not decoupled from each other.

Therefore, there is still the need of a system with low inertia in all DoFs which can be used to apply forces to a user in a precise manner over a large workspace while at the same time not requiring many strong actuators. More particularly, to apply forces in a precise manner means that the force rendering errors in each single DOF are at least one or two orders of magnitude smaller compared to the forces that the device aims to apply, for example to provide body weight support to a human user.

It is known from prior art that control performance in general can be improved by a minimal number of actuators and/or by letting high low-bandwidth forces be applied by different actuators than low high-bandwidth forces.

A specific mechanical configuration for the intended application, however, is unknown.

### SUMMARY OF THE INVENTION

It has now been found an apparatus which allows the manipulation of forces in a three-dimensional space with far lower actuator requirements and a much higher precision than prior-art systems.

The apparatus of the invention combines passive and active elements to minimize actuation requirements while still keeping inertia to a minimum and control precision to a maximum.

Therefore, it has the advantages that it requires minimal actuators but at the same time has a low inertia.

Furthermore, thanks to the specific apparatus design the DOFs requiring a large workspace and high-speed movements are decoupled from the DOFs in which high static forces are applied. This is reached by arranging the actuators and the points to which they apply their force/torque in a different way than in prior art. Differently sized and configured actuators are used, each of which has a different target load and speed and/or drives a different DOF.

The approach of the apparatus of the present invention to decouple the selected DOFs and frequency domains as well as to place the passive elements to enable decoupling of system inertia solves the above mentioned problems in an effective and more easily practicable way.

It is an object of the present invention an apparatus to apply forces to an object or a subject, in particular a person (herein intended also as user) as defined in the appended independent claim.

Other objects of the present invention as well as embodiments of the same will be defined in the dependent claims.

In particular, the apparatus of the invention comprises one or more ropes (or wires) (R₁, R₁′) wherein each rope extends from a first associated drive unit (Aₐ, A_{c},) to a first associated deflection device, respectively, (D₁, D₃) and is deflected by the latter, and wherein
said one or more ropes (R₁, R₁′) are guided by said first deflection devices (D₁, D₃) toward a second associated deflection device, respectively, (P₁, P₁′), whereby said one or more ropes (R₁, R₁′) are deflected by said second deflection device (P₁, P₁′) toward a third deflection device respectively (D₂, D₄) that is connected to said first deflection device, particularly in a rigid or elastic manner, and said ropes are deflected by said third deflection device toward a second associated drive unit (A_{b}, A_{d}) or a fixed point in space or back to said first associated deflection device (D₁, D₃,), wherein said second deflection devices (P₁, P₁′) are connected to an object or a subject (user) and said drive units (Aₐ, A_{b}, A_{c}, A_{d}) apply forces (Fₐ, F_{b}, F_{c}, F_{d}) to the respective one or more ropes (R₁, R′), which forces add up to a current resulting force vector (Fₙ) exerted on said user via said second deflection devices (P₁, P₁′), in order to apply forces and/or moments on said object or user and/or to unload said object or user.

In one embodiment, said second deflection devices (P₁, P₁′) are interconnected one with each other to a user through one or more common coupling points.

According to this embodiment it is also provided a modular version of the apparatus wherein both sides can be used individually as 2D versions, for example for two patients.

In one embodiment, the apparatus of the invention further comprises one or more further drive units (Aₜₐ, A_{tb}, A_{tc}, A_{td}) applying forces (Fₜₐ, F_{tb}, F_{tc}, F_{td}) to each first and third deflection devices (D₁, D₂, D₃, D₄) thus resulting in additional horizontal and/or vertical force components of Fₙ exerted on the user (4) via said second deflection devices (P₁, P₁′).

Said further forces (Fₜₐ, F_{tb}, F_{tc}, F_{td}) can be applied to said first and third deflection devices (D₁, D₂, D₃, D₄) through one or more further ropes (X′, X″, X′″, X″″) extending from said one or more further drive units (Aₜₐ, A_{tb}, A_{tc}, A_{td}) to said first and third deflection devices (D₁, D₂, D₃, D₄).

In a preferred embodiment, an elastic or viscoelastic connecting element (Y₁, Y₂, Y₃, Y₄), for example a spring or a rubber rope, is present between said one or more further ropes (X′, X″, X′″, X′′) and the respective deflection device(s) (D₁, D₂, D₃, D₄).

In an embodiment, only one further drive unit (Aₜₐ, A_{tc}) and only one further rope (X′, X′″) is present per each second deflection device (P₁, P₁′), said further rope extending from said first deflection device (D₁, D₃) through said further drive unit (Aₜₐ, A_{tc}) to said associated third deflection device (D₂, D₄) via a suitable arrangement of additional fixed deflection devices, so that said further drive units (Aₜₐ, A_{tc}) apply forces (Fₜₐ, F_{tb}, F_{tc}, F_{td}) to said first and third deflection devices (D₁, D₂, D₃, D₄) through said only one further rope (X′, X′″) per second deflection device.

Alternatively, said further forces (Fₜₐ, F_{tb}, F_{tc}, F_{td}) can be applied by one or more further drive units (Aₜₐ, A_{tb}, A_{tc}, A_{td}) directly attached to said first and third deflection devices (D₁, D₂, D₃, D₄) via additional ropes.

In another embodiment, the free ends of said rope (R₁, R₁′) are interconnected so that only one rope is present.

In a further embodiment, both free ends of the rope (R₁, R₁′) after being deflected by said first, second, and third deflection devices (D₁, D₃, P₁, P₁′, D₂, D₄,) are guided backwards by said third (D₂, D₄) deflection device with a deflection angle >90° over the first deflection device (D₁, D₃) and then extend to the respective drive unit (Aₐ, A_{b}, A_{c}, A_{d}).

In a preferred embodiment, a connecting element (C₁, C₂) is present between said first and third deflection devices (D₁, D₂, D₃, D₄) so as to form a deflection unit.

More preferably, said connecting element (C₁, C₂) is elastic or viscoelastic, for example a spring or a rubber rope.

The use of an elastic element connecting said further drive units (Aₜₐ, A_{tb}, A_{tc}, A_{td}) to said guided deflection devices (D₁, D₂, D₃, D₄) and/or said first and third guided deflection devices to each other is particularly advantageous since it decouples the motor inertia from the user so that the user does not perceive the inertia of the actuators. Furthermore, the use of an elastic element as a connecting element between said first and third guided deflection devices when further drive units are present allows to influence forces with high bandwidth in all DOFs by said further drive units (Aₜₐ, A_{tb}, A_{tc}, A_{td}) acting on the deflection devices.

In another embodiment, all deflection devices (D₁, D₂, D₃, D₄, P₁, P₁′) are replaced by double deflection devices and the rope (R₁, R₁′) is guided twice over each pair of deflection device.

In a further embodiment, one free end of the rope (R₁, R₁′) is fixed to a fixed point in space.

In a preferred embodiment, the apparatus comprises a first and a second rope (R₁, R₁′) wherein
the first rope (R₁) extends from a first associated drive unit (A_{c}) to a first associated deflection device (D₃) and is deflected by the latter, toward a second associated deflection device (P₁), is deflected by said second deflection device (P₁) toward a third deflection device (D₄) and is deflected by the latter toward a second associated drive unit (A_{d}), and
the second rope (R₁′) extends from a first associated drive unit (Aₐ) to a first associated deflection device (D₁) and is deflected by the latter, toward a second associated deflection device (P₁′), is deflected by said second deflection device (P₁′) toward a third deflection device (D₂) and is deflected by the latter toward a second associated drive unit (A_{b}), so that said drive units (Aₐ, A_{b}, A_{c}, A_{d}) apply forces (Fₐ, F_{b}, F_{c}, F_{d}) to the respective ropes (R₁, R₁′), which forces add up to a current resulting force (Fₙ) exerted on said user via said second deflection devices (P₁, P₁′), in order to apply a force and/or a moment on said user and/or to unload said user.

Preferably, the first and third deflection devices (D₁, D₂, D₃, D₄) are designed to be slidably connected to guiding rails.

Preferably, the apparatus of the invention further comprises at least a first guide rail running along a longitudinal axis and a second guide rail running along a longitudinal axis both extending horizontally with respect to an operating position of the apparatus, said guide rails being designed to be connected to a support structure, particularly to a support frame or to a ceiling of a room and said guide rails running parallel with respect to each other.

It is another object of the present invention a method for controlling the above disclosed apparatus, said method comprising measuring the position of the first and third deflection devices along the guide rails, measuring the forces applied on the subject (user) or the object using said apparatus, measuring the amount of rope released from each drive unit, combining this information to calculate the position of the second deflection devices (P₁, P₁′), and providing a feedback to said drive units so that a given reference force or position is tracked, in particular to unload the user or to apply horizontal forces.

Preferably the position of the deflection devices along the guide rails is measured, for example via optical sensors or magnetic sensors. Preferably, also the forces in the ropes R₁ and R₁′ and/or in the connecting elements (C₁, C₂) between said first and third deflection devices and/or in the ropes connecting said further drive units (Aₜₐ, A_{tb}, A_{tc}, Aₜₐ) to said first and third deflection devices (D₁, D₂, D₃, D₄) are measured, particularly by measuring deformation of an elastic or viscoelastic element (for example a linear spring or a rubber rope) connected to the ropes in series. This measurement can particularly be performed via strain gauges, wire potentiometers, optical sensing, or capacitive sensing. Preferably, also all drive units are equipped with sensors to measure the amount of rope that has been released, particularly via encoders on the actuators or on the winch axes. Using this sensor information, the resulting force and moment applied to the user is calculated by a kinematic mapping from the forces in the ropes (R₁, R₁′) to force vector and a moment vector in Cartesian space.

In one aspect of the invention, the force applied on the object or person is controlled in a feedback-loop in such a way that a given reference force is tracked, particularly to unload the user or to apply horizontal forces. To this end, the measured force vector is compared to the reference force vector, and the torques applied by the drive units are adjusted in such a way as to decrease the difference between these two vectors (Cartesian-space control). Alternatively, the reference force vector and the current kinematic configuration of the system can be used to calculate individual reference forces for each single rope, and the torque of each individual drive unit is adjusted in such a way as to decrease the difference between the respective reference rope force and the measured rope force (drive unit-space control). In addition or alternatively, the drive unit torques can also be applied as to achieve a given desired movement of the deflection units, particularly to keep these centered above the user.

In another aspect of the invention, the drive units are used to control a certain position of the user. All the above applies in an analog way, only that not forces but positions are controlled either in Cartesian space or in drive unit space.

Preferably, the control is split into high-frequent and low-frequent portions, whereby said drive units (Aₐ, A_{b}, A_{c}, A_{d}) control primarily low-frequent portions, and said further drive units (Aₜₐ, A_{tb}, A_{tc}, A_{td}) control primarily high-frequent portions.

### DETAILED DESCRIPTION OF THE INVENTION

### Definitions

Within the meaning of the present invention, the term “user” preferably refers to a human person, but may also refer to an animal or to any object that is to unload and/or move.

Preferably, said user is a subject affected by a spinal cord motor disorder, wherein for spinal cord motor disorder is intended a disorder wherein the spinal cord is damaged and locomotor and postural functions are impaired. A spinal cord motor disorder can be caused and subsequent to trauma, infection factors (for example, extrapulmonary tuberculosis), cancer diseases, Parkinson's disease, multiple sclerosis, amyotrophy lateral sclerosis or stroke. More preferably, said user is a subject affected by spinal cord injury. Within the meaning of the present invention, spinal cord injury refers to any injury to the spinal cord that is caused by trauma.

Within the meaning of the present invention, the term “deflection device” means a device which guides the rope and changes its direction, particularly guiding it into the workspace.

### FIGURES

FIG. 1 shows an exemplary apparatus according to the invention in a support structure.

FIG. 2 shows an exemplary apparatus according to an embodiment of the invention in a support structure.

FIG. 3 shows a 2D configuration of an embodiment of the apparatus of the invention. This can be combined with a second identical mechanism by connecting the second deflection devices (P1, P1′).

FIG. 4 shows a 2D configuration of an embodiment of the apparatus of the invention. This can be combined with a second identical mechanism by connecting the second deflection devices (P1, P1′).

FIG. 5 shows a 2D configuration of an embodiment of the apparatus of the invention. This can be combined with a second identical mechanism by connecting the second deflection devices (P1, P1′).

FIG. 6 shows a 2D configuration of an embodiment of the apparatus of the invention. This can be combined with a second identical mechanism by connecting the second deflection devices (P1, P1′).

FIG. 7 shows a 2D configuration of an embodiment of the apparatus of the invention. This can be combined with a second identical mechanism by connecting the second deflection devices (P1, P1′).

FIG. 8 shows a 2D configuration of an embodiment of the apparatus of the invention. This can be combined with a second identical mechanism by connecting the second deflection devices (P1, P1′).

FIG. 9 shows a 2D configuration of an embodiment of the apparatus of the invention. This can be combined with a second identical mechanism by connecting the second deflection devices (P1, P1′).

FIG. 10 shows a 2D configuration of an embodiment of the apparatus of the invention. This can be combined with a second identical mechanism by connecting the second deflection devices (P1, P1′).

Preferably, the first and third deflection devices (D₁, D₂, D₃, D₄) are passively displaceable (i.e. can change their position in space, particularly in a guided manner), which particularly means that they do not themselves comprise a movement generating means for moving the respective deflection device actively, but can be displaced by forces induced into the deflection devices via the ropes connected to the user or via drive units attached to them via additional ropes.

Preferably, the first and third deflection devices (D₁, D₂, D₃, D₄) are connected to each other (for instance pairwise such that the respective two deflection devices can be displaced together while maintaining a constant distance between the deflections devices along the direction of displacement), and they may be guided by a guide rail or a plurality of guide rails or may be suspended from a support structure (e.g. support frame or ceiling of a room), particularly by means of a wire or another (elongated) supporting element such that their centers of mass can (passively) change position in space. Likewise, said guide rail(s) may be connected to a support structure (e.g. support frame or ceiling).

However, in an embodiment of the invention, the deflection devices may be fixed such that they are not moving in space or along the guide rails. Particularly, the deflection devices can be designed to be fixed in a releasable manner to the guide rails so that the deflection units are temporarily lockable regarding their movement along the guide rails.

A connection between two (or even more) deflection elements can be provided by means of a (e.g. separate) connecting means (element), which may be interchangeable. Said connecting element is preferably elastic (particularly such that the restoring force is a function of the elongation of the elastic connecting element, particularly a linear function) or viscoelastic or non-elastic, so as to form a deflection unit (also denoted as trolley). Further, the respective connecting element may be a flexible rope member or a rigid rod (particularly produced out of a carbon fibre composite).

Deflection devices may also be integrally connected to each other (i.e. form a single piece).

Optionally, this connecting element can be realized via additional pulleys on either end of the rail, such that a tension spring in this connection generates forces that pushes the deflection devices apart instead of pulling them towards each other.

Each pair of first and third deflection devices (D₁, D₂, D₃, D₄) is used to guide a rope (R₁, R₁′) towards a freely moving, interconnected deflection device (P₁, P₁′).

In an embodiment of the invention, the apparatus comprises two ropes.

Preferably, the first rope extends from its first associated drive unit towards a first deflection device, is deflected by the first guided deflection device towards a second freely moving deflection device which deflects it to a third guided deflection device, preferably connected with said first deflection device, and then extends to a second associated drive unit. Likewise, the second rope extends from its first associated drive unit towards a first deflection device, is deflected by the first deflection device towards a second freely moving deflection device which deflects it to a third guided deflection device, preferably connected with said first deflection device and then extends to a second associated drive unit. The second deflection devices are connected to a common user and preferably also interconnected with each other through a common coupling point.

In another embodiment of the invention, in particular in the case of a human user, each of the second deflection devices can be connected to the respective shoulder of the user. Then the person could not rotate freely anymore, but rotation could be actuated.

Preferably, the first and third deflection devices are connected to each other on the same side to form a deflection unit, so that their combined movement is governed by (multiple) rope forces acting on them.

According to an aspect of the invention, the apparatus comprises at least a first guide rail and a second guide rail (for instance in case of two ropes), each running along a longitudinal axis. These longitudinal axes preferably extend horizontally with respect to an operating position of the apparatus, in which the apparatus can be operated (e.g. by the user) as intended. Preferably, the guide rail(s) can be connected to said support structure (e.g. support frame or ceiling of a room, in which the apparatus is arranged). In case of a support frame, the guide rail(s) may be connected to said upper frame part. Preferably, the guide rails are arranged such that they run parallel with respect to each other. Particularly, in case of two guide rails, each guide rail may be tilted about its longitudinal axis, particularly by an angle of 30° or 45° with respect to the vertical.

Preferably, the first and the third deflection device which guide a first rope are slidably connected to the first guide rail, so that they can slide along the first guide rail along the longitudinal axis of the first guide rail. In case of two ropes the first and the third deflection devices which guide a second rope are preferably slidably connected to the second guide rail, so that they can slide along the second guide rail along the longitudinal axis of the second guide rail.

In detail, said deflection devices may comprise a base (preferably in the form of a cart) slidably connecting the respective each deflection device to its associated guide rail. An arm hinged to its base can be provided for each deflection device so that each respective arm can be pivoted with respect to its base about a pivoting axis running parallel to the longitudinal axis of the respective guide rail. Each deflection device may also comprise a deflection element connected to the respective arm, for deflecting the respective rope around said deflection element. Each respective deflection element may be formed by a roller, which is rotatably supported on the respective arm, therefore the respective roller can be rotated about a rotation axis that is orthogonal to the longitudinal axis of the respective guide rail. If desired, arresting means can be provided for each deflection device for arresting the respective deflection device with respect to the associated guide rail, for instance when using the apparatus with a treadmill.

The first and third deflection devices guide the rope towards the second deflection devices. Differently from the above described first and third deflection devices, the second deflection devices are freely moving. Therefore, they are not connected to a guide rail but they can freely move in the workspace. They are connected to a user and preferably also interconnected with each other, e.g. by means of karabiners, and/or through one or more common coupling points to the user. In one embodiment, said second deflection devices are connected to a user through a single common point to which, for example, a harness is attached. In an alternative embodiment, said user is a human subject and second deflection devices are connected to the user by connecting each said second deflection device to one shoulder of the subject, such that rotation about the vertical axis can be induced and controlled.

In an embodiment, the free ends of the rope(s) is(are) connected to one or more drive units applying forces to said free ends.

In one embodiment, for each rope there are two drive units applying forces on the free ends of said rope. Preferably, the first drive unit of one rope and the second drive unit of the same rope face each other along the longitudinal axis of the first guide rail, wherein the first and the third deflection unit are arranged between said first and second drive units along the longitudinal axis of the guide rail.

In a preferred embodiment, one free end of each rope is connected to a drive unit, whereas the other free end of the same rope is fixed to a fixed point in space.

In a preferred embodiment, each drive unit comprises an actuator (for example a servo motor) which is connected to a winch, around which the respective rope is wound. A flexible coupling can be conveniently used. In this embodiment, each actuator is designed to exert a torque on the respective winch via a drive axis of the respective winch so as to retract or release the respective rope, i.e. to adjust the length of the respective rope that is unwound from the winch. If desired, each drive unit may comprise a brake for arresting the respective winch. Further, the drive unit preferably comprises at least one pressing member, for example in the form of a pressure roller pressing the respective rope being wound around the associated winch with a pre-definable pressure against the winch in order to prevent the respective rope from jumping off the associated winch or over a thread. In an alternative embodiment, the drive units are manually operated.

Optionally, a force is applied to each guided deflection device by means of further drive units.

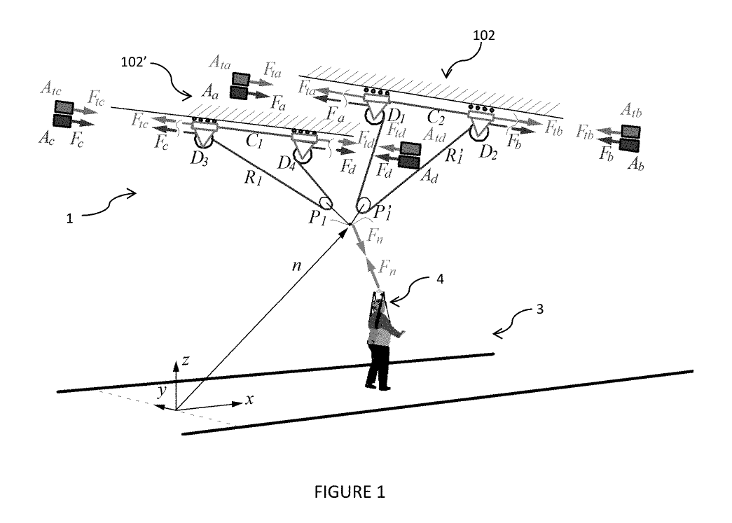

An exemplary embodiment of the apparatus according to the invention is depicted in FIG. 1.

The apparatus (1) comprises a suitable support structure (e.g. ceiling of the room where the apparatus is placed or a support frame—this latter not shown in FIG. 1), such that said support structure confines a three-dimensional working space (3), in which the user (4) can move along the horizontal x-y-plane (as well as vertically in case corresponding objects, e.g. inclined surfaces, staircases etc., are provided in the working space (3)). Said working space (3) then extends below said ceiling or frame.

Said support structure supports a first and a second guiding rail (102, 102′). The first guide rail 102 is designed to slidably support a two deflection devices D₁, D₂, and the second guide rail 102′ is designed to slidably support two further deflection devices D₃, D₄. Here, the pair D₁, D₂ as well as the pair D₃, D₄ are connected by a connecting means C₁, C₂ so that the two pairs of deflection devices D₁-D₂ and D₃-D₄ each form a deflection unit (trolley) which can slide along the respective guide rail (102, 102′).

A first rope R₁ extends from a first associated drive unit A_{c} to a first associate deflection device D₃ and is deflected by D₃ and guided toward a second associated deflection device P₁. The rope R₁ is then deflected by said second deflection device P₁ toward a third deflection device D_{4,} which is connected to said first deflection device D₃ through a connecting element C₁, and then extends to a second associated drive unit A_{d}.

Said drive units A_{d}, A_{c} apply forces F_{d}, F_{c} to the rope R₁ retracting and releasing it.

A second rope R₁′ extends from a first associated drive unit Aₐ to a first associate deflection device D₁ and is deflected by D₂ and guided toward a second associated deflection device P₁′. The rope R₁′ is deflected by said second deflection device P₁′ toward a third deflection device D₂, which is connected to said first deflection device D₁ through a connecting element C₂, and then extends to a second associated drive unit A_{b}.

Said drive units Aₐ, A_{b} apply forces Fₐ, F_{b} to the rope R₁′ retracting and releasing it. Preferably, said connecting elements C₁, C₂ are elastic or viscoelastic. A damper can also be used.

Said second deflection devices P₁, P₁′ are coupled to a user and preferably also interconnected one with each other.

A resulting force Fₙ is generated which is exerted on the user via deflection devices P₁, P₁′. In such a way the user is partially unloaded of its weight and a force is applied on the user.

Furthermore, a force is applied to each first and third deflection device D₁, D₂, D₃, D₄ by means of further drive units Aₜₐ, A_{tb}, A_{tc}, A_{td}. In particular, drive unit Aₜₐ exerts on deflection device D₁ a force Fₜₐ through rope X′. Drive unit A_{tb} exerts on deflection device D₂ a force F_{tb} through rope X″. Drive unit A_{tc} exerts on deflection device D₃ a force F_{tc} through rope X′″. Drive unit A_{td} exerts on deflection device D₄ a force F_{td} through rope X″″.

Forces Fₜₐ, F_{tb}, F_{tc}, F_{td} are applied in parallel directions with respect to the guide rails.

Their combined action results in additional horizontal and/or vertical force components which modify the resulting force Fₙ exerted on the user.

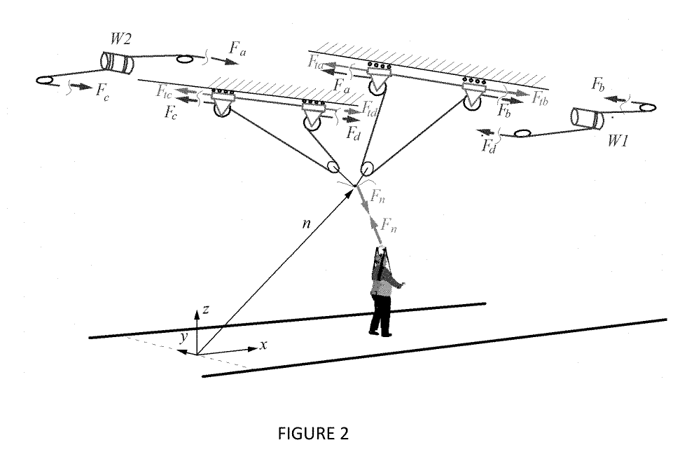

An embodiment of the invention is represented in FIG. 2.

In said embodiment, the free ends of each rope (R₁, R₁′) are interconnected so that only one rope is present (drive units Aₜₐ, A_{tb}, A_{tc}, A_{td} not depicted for matter of clarity).

One free end extends from a first actuated winch (drive unit) W₁ to a second actuated winch (drive unit) W₂ and then back to said first actuated winch W₁, wherein both free ends are wound up. Each winch W₁, W₂ is preferably placed between the ends of the guiding rails, one facing the other.

In this embodiment, R₁ and R₁′ refer to each rope part extending from a first drive unit (or winch) to a second drive unit (or winch).

Preferably, the winch W₁, W₂ is a torque- or position-controlled winch. A torque-controlled winch provides an actuator torque that aims to decrease the difference between a given reference torque and the currently measured torque, particularly as measured from the force ensors in the ropes or calculated from current measurement of the actuator unit. A position-controlled winch provides an actuator torque that aims to decrease the difference between a reference length for the rope that is released and the actual length of rope released, particularly as measured by an encoder on the drive unit. The reference force or position is provided by a control algorithm, particularly as the one described earlier.

Typically, one of the two winches, for example W₁, acts by changing the overall length of the rope while the other, for example W₂, has the role of manipulating the relative lengths of the rope parts R₁ and R₁′.

Optionally, only one of the two winches is present, for example W₁.

Similar to the previous exemplary embodiment, winch W₁ apply forces F_{b}, F_{d} to the rope retracting and releasing it, while winch W₂ apply forces Fₐ, F_{c} to the rope retracting and releasing it.

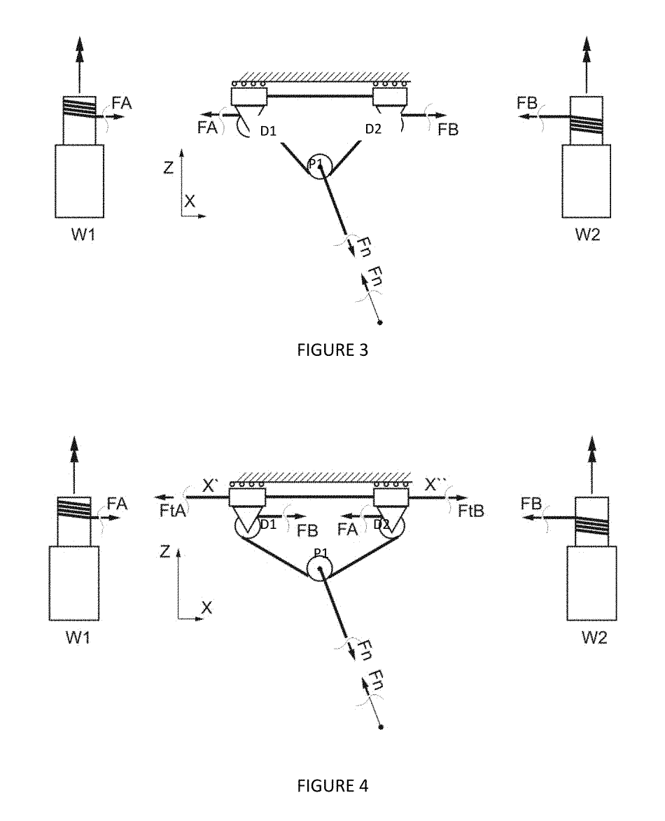

A 2D configuration of this same embodiment is represented in FIG. 3, wherein both ends of the rope are connected to winches W₁, W₂ so that forces Fₐ, F_{b} are respectively generated on the rope by said winches W₁ and W₂. A resulting force Fₙ is exerted on the user.

As for the exemplary embodiment above described, forces Fₜₐ, F_{tb}, F_{tc}, F_{td} are applied on the deflection devices in parallel directions with respect to the guide rails by drive units not shown in the picture.

All embodiments of the apparatus of the invention that are depicted as 2D configurations are preferably intended to be deployed in a 3D configuration as depicted in FIG. 1 or 2 by means of duplicating the mechanisms and interconnecting the second deflection devices P₁ and P₁′ directly or through connection to a common user. Since the focus is on the connection of the deflection devices, the various configurations are only shown in 2D.

A further embodiment of the invention is represented in FIG. 4.

As explained above, this embodiment is intended to be realized in a three-dimensional configuration but is herein depicted on a two-dimensional configuration for ease of representation.

In this embodiment, both free ends of the rope R₁ after being deflected by deflection devices D₁, P₁ and D₂ are guided backwards, with a deflection angle >90°, over the guided deflection devices D₁, D₂ and then connected to motorized winches W₁, W₂.

Forces Fₐ, F_{b} are respectively generated on the rope by said winches W₁ and W₂.

The configuration is represented only for one rope or part of the rope R₁ but it is intended to be the same for the other rope or part of the rope R₁′.

Preferably, an elastic connecting element is also present between deflection devices D₁, D₂ so that said deflection devices D₁, D₂ are pushed apart instead of being pulled towards each other.

The advantage of this configuration is that when the force on the rope or part of the rope R₁ increases, the deflection devices D₁ and D₂ on the same rail will move towards each other, and vice versa. That in turn reduces the difference in forces between rope or part of the rope R₁ and rope or part of the rope R₁′.

This is particularly advantageous, for example, when the user moves in y direction with a desired constant force Fₙ pointing in z direction.

For appropriately dimensioned elastic element, this can even lead to zero torque to be applied by winch W₁ over a certain range of y positions, said range being between −1 m and +1 m of lateral movement. In these cases the rope parts R₁, R₁′ can be connected directly to each other, without using winch W₁.

Preferably, in this embodiment deflection devices D₁ and D₂ are not fully aligned with respect to the guiding rail.

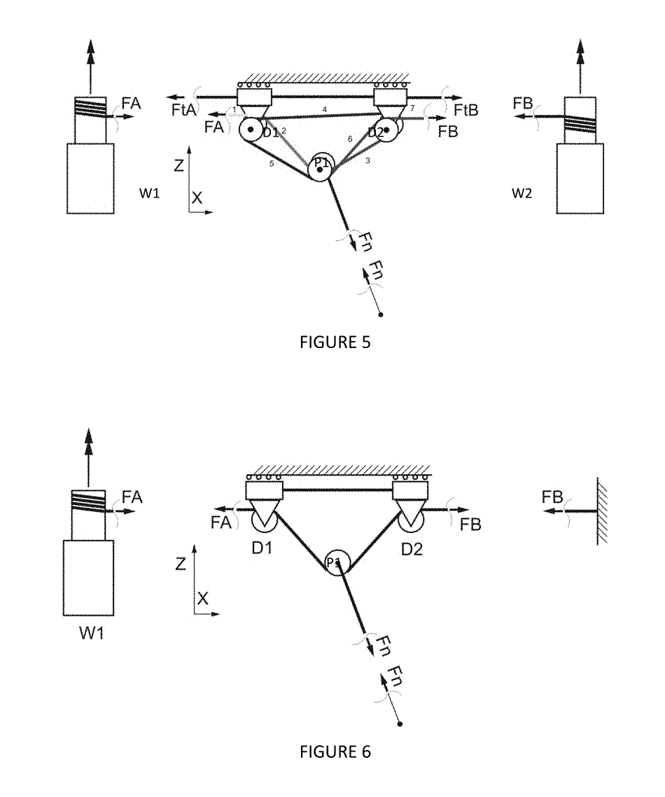

A further embodiment of the invention is represented in a 2D configuration in FIG. 5.

This embodiment is intended to be realized in a three-dimensional configuration but is herein depicted on a two-dimensional configuration for ease of representation.

The configuration is represented only for one part of the rope R₁ but it is intended to be the same for the other part of the rope R₁′.

In this embodiment, all deflection devices D₁, D₂, P₁ are replaced by double deflection devices and the rope R₁ is guided twice over each pair of deflection device.

In particular, the rope R₁ extends from a first winch W₁ and is guided over one pair of guided deflection devices D₁, then guided towards a pair of freely moving deflection device P₁ and via this one guided to the third pair of deflection devices D₂ guided by the same rail, then deflected by them back to D₁, then again to P₁, from these again to D₂, and finally to the second winch W2.

One advantage of this configuration is that in a 3D configuration there are in total eight rope parts that support the load Fₙ thus reducing the necessary load of W₂.

Further advantages are that it is easier to guide the ropes and that D₁ and D₂ may stay aligned, differently from the embodiment depicted in FIG. 4.

Preferably, an elastic connecting element is present between deflection devices D₁, D₂ so that said deflection devices D₁, D₂ are pushed apart instead of being pulled towards each other.

As for the exemplary embodiment above described, forces Fₜₐ, F_{tb} are applied on the deflection devices in parallel directions with respect to the guide rails by drive units not shown in the picture.

A further embodiment of the invention is represented in a 2D configuration in FIG. 6.

In this embodiment, one free end of each rope R₁ is fixed at one end of each respective guiding rail.

The remaining free end is connected to a respective motorized winch W₁ on the opposite end of the guiding rail, or all the free ends of each rope are connected to a joint winch W₂ on the opposite end of the guiding rail.

In all the above embodiments, one drive unit (or winch) can be replaced by the fixation of one free end of the rope R₁, R₁′ to a fixed point (for example a wall or the end of the guiding rail).

In further embodiments of the invention a one- or bi-directional force is applied to each guided deflection device D₁, D₂, D₃, D₄ by means of further drive units Aₜₐ, A_{tb}, A_{tc}, Aₜₐ.

By means of these drive units, forces in parallel direction with respect to the rails are applied to the deflection devices D₁, D₂, D₃, D₄ and, therefore, to the user.

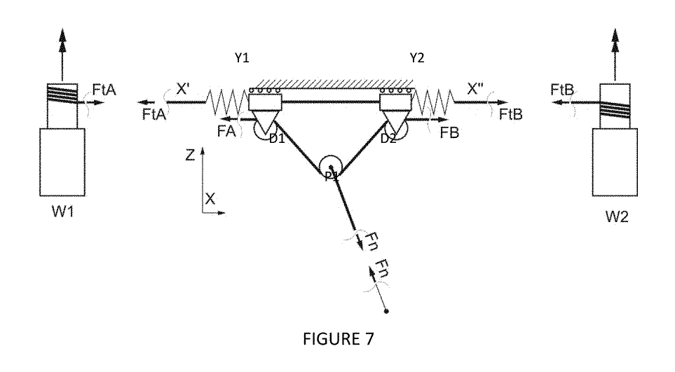

In this respect, an embodiment of the invention is represented in a 2D configuration in FIG. 7, wherein two motorized winches W₁, W₂ pull on respectively ropes X′, X″ connected directly via springs (depicted) to the deflection devices D₁, D₂ thus applying on said deflection devices a force Fₜₐ and a force F_{tb}, respectively.

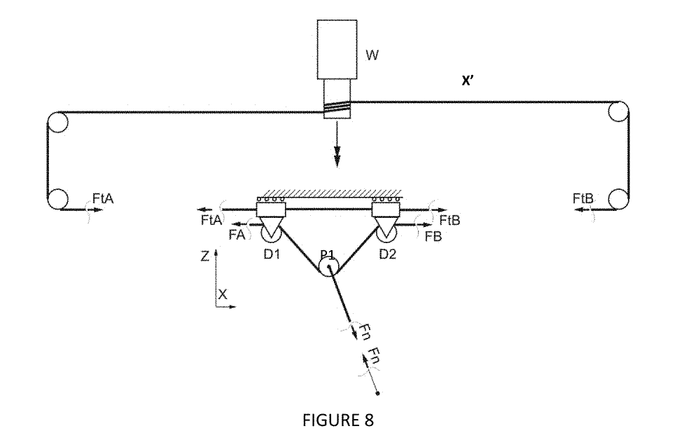

An alternative embodiment is depicted in FIG. 8.

Here, a single motorized winch W pulls on one rope R₁ whose free ends are connected to the deflection devices D₁, D₂. Forces Fₜₐ, F_{tb} are thus applied on the deflection devices D₁, D₂.

The advantage of this configuration is that only one motor is needed instead of two to apply forces to the two guided deflection devices D₁, D₂.

The disadvantage is that no opposed forces can be generated on the two guided deflection devices D₁, D₂.

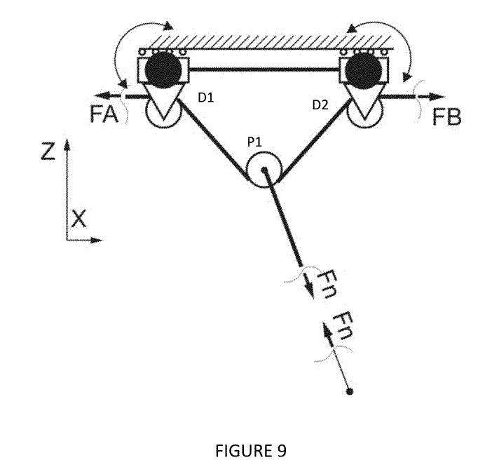

A further alternative embodiment is depicted in FIG. 9.

Here, the deflection devices D₁, D₂ are directly actuated, e.g. by actuators directly attached to the carts of the deflection devices via additional ropes (not depicted in the figure). Therefore, forces Fₜₐ, F_{tb} are applied to the deflection devices D₁, D₂.

The advantage is that no winches are needed to wind up the rope attached to the deflection devices. The disadvantage is the increased mechanical complexity (guidance of actuator cables and guidance system) and the potentially increased inertia.

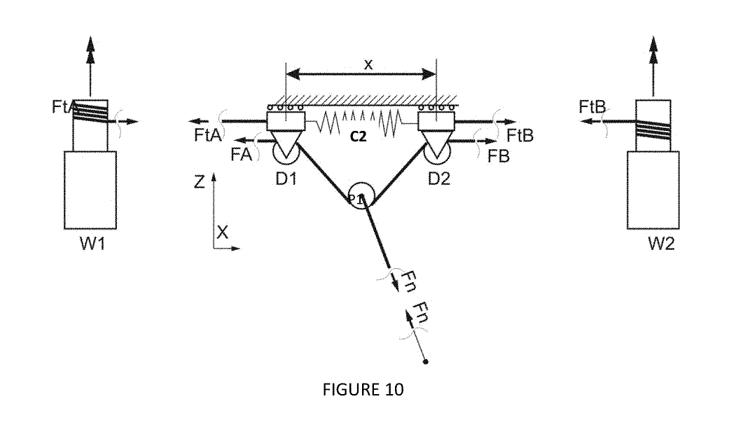

A further embodiment of the apparatus according to the present invention is represented in FIG. 10.

In this embodiment, the guided deflection devices D₁, D₂ are connected by means of an elastic element C₂.

In such a way, when opposed forces are applied on said deflection devices by the drive units, the distance between said devices changes.

For example, if four motorized winches Wi-W4 are present (only two are depicted in FIG. 10 for ease of representation) and they all pull with the same force on the ropes X′, X″ connected to the deflection devices D₁, D₂, the vertical force on the user is released with an increase of forces Fₜₐ, F_{tb}, F_{tc}, F_{td}.

If only the motorized winches on one guiding rail W₁, W₂ pull with about the same force, then the user is pulled towards the opposite guiding rail.

If unilateral forces with equal direction are applied to both pairs of guided deflection units D₁-D₂ and D₃-D₄, a force in x-direction is generated on the user.

If unilateral forces with opposed direction are applied to both pairs of guided deflection units D₁-D₂ and D₃-D₄, the vertical force is increased.

In an embodiment, deflection devices P₁, P₁′ are connected to the user through two different coupling points. In this case, if unilateral forces with opposed direction are applied to both pairs of guided deflection units D₁-D₂ and D₃-D₄, a rotation of the user about the vertical axis is induced.

In a preferred embodiment, this configuration is used together with the configuration depicted in FIG. 4, i.e. with both free ends of the ropes or rope parts R₁ and R₁′ guided backwards over the guided deflection devices.

In this case, the influence of actuation on the deflection devices is inverted, and required actuator forces for y-actuation and z-actuation are generally reduced.

In an alternative embodiment, this configuration is used together with the configuration depicted in FIG. 5, i.e. with all deflection devices replaced by double deflection devices.

Also in this case, the influence of actuation on the deflection devices is inverted, and required actuator forces for y-actuation and z-actuation are generally reduced.

The apparatus herein disclosed is also for use and in a method in restoring voluntary control of locomotion in a subject suffering from a neuromotor impairment.

Generally, the apparatus according to the present invention is for use and in a method for locomotor rehabilitation of a subject, in particular a human, suffering from locomotor impairment, as detailed in the specification.

In the unitary concept of the present invention, the apparatus of the present invention, is for the above mentioned uses, optionally in combination with a device for epidural and/or subdural electrical stimulation, and further optionally in combination with a cocktail comprising a combination of agonists to monoaminergic receptors, as disclosed for example in WO2013179230, WO2015000800.

1. Apparatus (1) comprising:
two or more ropes (or wires) or two parts of one rope (R₁, R₁′), also referred to as primary rope(s), wherein each rope or rope part extends from a first associated drive unit (Aₐ, A_{c}) to a first associated deflection device, respectively, (D₁, D₃) and is deflected by the latter, and wherein
each rope or rope part (R₁, R₁′) is guided by said first deflection device (D₁, D₃) toward a second associated deflection device, respectively, (P₁, P₁′), whereby said rope or rope part (R₁, R₁′) is deflected by said second deflection device (P₁, P₁′) toward an associated third deflection device, respectively, (D₂, D₄), that is connected to the respective first deflection device (D₁, D₃), and said rope or rope part (R₁, R₁′) is deflected by said third deflection device (D₂, D₄) toward a second associated drive unit (A_{b}, A_{d}) or a fixed point in space or back to said first associated deflection device (D₁, D₃),
wherein said second deflection devices (P₁, P₁′) are connected to an object or a user.

2. Apparatus according to claim 1, wherein said second deflection devices (P₁, P₁′) are interconnected one with each other to said object or user through one or more common coupling points.

3. Apparatus according to claim 1 or 2, further comprising one or more further drive units (Aₜₐ, A_{tb}, A_{tc}, A_{td}) applying forces (Fₜₐ, F_{tb}, F_{tc}, F_{td}) to each first and third deflection device (D₁, D₂, D₃, D₄) thus resulting in additional horizontal and/or vertical force components of Fₙ exerted on said user (4) via said second deflection devices (P₁, P₁′).

4. Apparatus according to claim 3, wherein said further forces (Fₜₐ, F_{tb}, F_{tc}, F_{td}) are applied to said first and third deflection devices (D₁, D₂, D₃, D₄) through one or more further ropes (X′, X″, X′″, X″″), also referred to as secondary ropes, extending from said one or more further drive units (Aₜₐ, A_{tb}, A_{tc}, A_{td}) to said guided first and third deflection devices (D₁, D₂, D₃, D₄).

5. Apparatus according to claim 3, wherein only one further drive unit (Aₜₐ, A_{tc}) and one further rope (X′, X”') per each second deflection device (P₁, P₁′) is present, said further rope (X′, X′″) extending from said first deflection device (D₁, D₃) through said further respective drive unit (Aₜₐ, A_{tc}) to said associated third deflection device (D₂, D₄) so that said further drive units apply forces (Fₜₐ, F_{tb}, F_{tc}, F_{td}) to said deflection devices (D₁, D₂, D₃, D₄) through said further ropes (X′, X″).

6. Apparatus according to claim 3, wherein said further forces (Fₜₐ, F_{tb}, F_{tc}, F_{td}) are applied by one or more further drive units (Aₜₐ, A_{tb}, A_{tc}, A_{td}) directly attached to said first and third deflection devices (D₁, D₂, D₃, D₄) via additional ropes.

7. Apparatus according to anyone of claims 3-6, wherein said further drive units (Aₜₐ, A_{tb}, A_{tc}, A_{td}) are connected to said first deflection devices (D₁, D₂, D₃, D₄) through an elastic or viscoelastic connecting element, preferably a spring or a rubber rope.

8. Apparatus according to anyone of the preceding claims, wherein only one primary rope is present, said rope comprising two rope parts (R₁, R₁′), each rope part extending from a first drive unit to a second drive unit or to a winch.

9. Apparatus according to claim 8, wherein said only rope (R₁, R₁′) extends from a first drive unit (W₁) to a second drive unit (W₂) and then back to said first drive unit (W₁).

10. Apparatus according to claim 8 or 9, wherein said first drive units (Aₐ, A_{c}) are connected to form one combined drive unit in such a way that a rotation of the winch of said combined drive unit in one direction leads to the rope being released on one side of the combined drive unit and also released on the other side of the combined drive unit, while rotation of the winch in the opposite direction leads to retraction of the rope on both sides of the combined drive unit.

11. Apparatus according to anyone of claims 8-10, wherein said second drive units (A_{b}, A_{d}) are connected to form one combined drive unit, in such a way that a rotation of the winch of said combined drive unit in one direction leads to rope being retracted on one side of the combined drive unit and to the rope being released on the opposite side of the combined drive unit.

12. Apparatus according to anyone of claims 10-11, wherein in said combined drive unit, each winch has a variable radius which is decreasing or increasing toward the extremities and the decrease is symmetrical for both winches.

13. Apparatus according to claim 8, wherein said only rope extends from a first drive unit to a winch then to a second drive unit.

14. Apparatus according to claim 13, wherein said winch is completely passive or it is actuated by a motor.

15. Apparatus according to anyone of claims 13-14 wherein said winch (W₂) comprises two halves, each half having a variable radius, said variable radius being decreasing or increasing toward the extremities and the decrease is symmetrical for both halves of the winch.

16. Apparatus according to claim 8, wherein said only rope extends from a first drive unit to a second drive unit and then to a third drive unit, which is preferably on the same side of said first drive unit.

17. Apparatus according to claim 16 wherein said second drive unit comprises two winches having a variable radius, said variable radius being decreasing or increasing toward the extremities and the decrease is symmetrical for both winches.

18. Apparatus according to anyone of the preceding claims, wherein a winch comprises a groove guiding said rope on the winch, such groove preferably having a variable lead.

19. Apparatus according to claim 12, 15 or 17 wherein said winch or said half of the winch having a variable radius also has a groove with a variable lead.

20. Apparatus according to claim 19 wherein said variable radius and/or said variable lead are adjusted so that the convex hull or envelope of the drum is a cone or a double cone.

21. Apparatus according to anyone of the preceding claims, wherein said winch is connected to a passive damping element or it is a completely passive winch.

22. Apparatus according to anyone of the preceding claims, wherein both free ends of said primary rope (R₁, R₁′) extending from a first drive unit (Aₐ, A_{b}, A_{c}, A_{d}) to a first associated deflection device (D₁, D₃), after being deflected by said first and second deflection devices (D₁, D₃, P₁, P₁^{′}) towards a third deflection device (D₂, D₄) are guided backwards by said third deflection device (D₂, D₄) with a deflection angle >90° over said first deflection devices (D₁, D₃) and then extend to the respective second drive unit (Aₐ, A_{b}, A_{c}, A_{d}).

23. Apparatus according to anyone of the preceding claims, wherein a connecting element (C₁, C₂) is present between said first and third deflection devices (D₁, D₂, D₃, D₄) so as to form a single deflection unit.

24. Apparatus according to claim 23 wherein said connecting element (Cᵢ, C₂) is elastic, preferably a spring.

25. Apparatus according to anyone of the preceding claims, wherein each said deflection device (D₁, D₂, D₃, D₄, P₁, P₁′) is replaced by a double deflection device and the rope (R₁, R₁′) is guided twice over each pair of deflection devices.

26. Apparatus according to claim 25, wherein each said rope (R₁, R₁′) extends from a first drive unit (W₁), is guided over a pair of said first deflection devices (D₁), then guided towards a pair of said second deflection devices (P₁) and via the latter is guided to a pair of said third deflection devices (D₂) on the same rail, then is deflected by them back to said pair of said first deflection devices (D₁), then again to said pair of said second deflection devices (P₁), then from these again to said pair of third deflection devices (D₂), and finally to a second drive unit (W₂).

27. Apparatus according to anyone of the preceding claims, wherein one free end of said rope (R₁, R₁′) is fixed to a fixed point in space.

28. Apparatus according to claim 27, wherein an elastic element (E), preferably a spring, is present between said first or third deflection devices (D₁, D₂, D₃, D₄) and the respective drive unit (W₁).

29. Apparatus according to anyone of the preceding claims wherein one free end of said rope (R₁, R₁′) is fixed to a fixed point in space and the other free end is wound up to a drive unit (W1) and an elastic element (E), preferably a spring, is present between said first deflection device (D₁, D₃) and said drive unit.

30. Apparatus according to claim 29, wherein said first and third deflection devices (D₁, D₂, D₃, D₄) are slidably connected to a guide rail and one free end of each rope (R₁, R₁′) is fixed at one end of each respective guiding rail and the remaining free end of the same rope (R₁, R₁′) is connected to a respective drive unit (W₁) on the opposite end of said guiding rail.

31. Apparatus according to claim 29, wherein said first and third deflection devices (D₁, D₂, D₃, D₄) are slidably connected to a guide rail and one free end of each rope (R₁, R₁′) is fixed at one end of each respective guiding rail and all the remaining free ends of each rope (R₁, R₁′) are connected to a joint drive unit (W₂) on the opposite end of said guiding rail.

32. Apparatus according to anyone of the preceding claims, wherein said apparatus comprises a first and a second rope (R₁, R₁′) wherein said first rope (R₁) extends from a first associated drive unit (Aₛ) to a first associated deflection device (D₃) and is deflected by the latter, toward a second associated deflection device (P₁), is deflected by said second deflection device (P₁) toward a third deflection device (D₄) and is deflected by the latter toward a second associated drive unit (A_{d}), and said second rope (R₁′) extends from a first associated drive unit (Aₐ) to a first associated deflection device (D₁) and is deflected by the latter, toward a second associated deflection device (P₁′), is deflected by said second deflection device (P₁′) toward a third deflection device (D₂) and is deflected by the latter toward a second associated drive unit (A_{b}), so that said drive units (Aₐ, A_{b}, A_{c}, A_{d}) apply forces (Fₐ, F_{b}, F_{c}, F_{d}) to the respective rope (R₁, R₁′), which forces add up to a current resulting force (Fₙ) exerted on said user via said second deflection devices (P₁, P₁′), in order to apply forces and/or moments on said user and/or to unload said user.

33. Apparatus according to anyone of the preceding claims wherein said first and third deflection devices (D₁, D₂, D₃, D₄) are designed to be slidably connected to a guiding rail (102, 102′).

34. Apparatus according to anyone of the preceding claims, wherein said apparatus further comprises at least a first guide rail (102) running along a longitudinal axis and a second guide rail (102′) running along a longitudinal axis both extending horizontally with respect to an operating position of the apparatus, said guide rails (102, 102′) being designed to be connected to a support structure, particularly to a support frame or to a ceiling of a room and said guide rails running parallel with respect to each other.

35. Apparatus according to anyone of the preceding claims, wherein said drive units (Aₐ, A_{b}, A_{c}, A_{d}, Aₜₐ, A_{tb}, A_{tc}, A_{td}) are used to control a certain position of the user (4) or forces/moments acting on the user (4) and the control is split into high-frequency and low-frequency portions, whereby said drive units (Aₐ, A_{b}, A_{c}, A_{d}) control primarily low-frequency portions, and said further drive units (Aₜₐ, A_{tb}, A_{tc}, A_{td}) control primarily high-frequency portions.

36. Apparatus according to anyone of the preceding claims, wherein one or more further deflection devices (S₁, S₂) are present between said first or third deflection devices (D₁, D₂, D₃, D₄) and the respective drive unit (Aₐ, A_{b}, A_{c}, A_{d}).

37. Apparatus according to anyone of the preceding claims, wherein all the drive units of the apparatus do not comprise any motor.

38. Apparatus of any one of claims 1-37 for use in locomotor rehabilitation of a subject.
